(19) United States
(12) Patent Application Publication
(10) Pub. No.: US 2009/0000487 A1
(43) Pub. Date: Jan. 1, 2009

(54) Device for Aromatising Liquids for Human Consumption, Such as Wine, Vinegar, Distillates and the Like

(76) Inventor: Galtieri Giuseppe, Messina (IT)

Correspondence Address: YOUNG & THOMPSON, 209 Madison Street, Suite 500, ALEXANDRIA, VA, 22314, US

(21) Appl. No.: 10/588,765

(22) PCT Filed: Feb. 9, 2005
(86) PCT No.: PCT/IT2005/000059

§ 371 Date: Aug. 8, 2006

(30) Foreign Application Priority Data
Feb. 12, 2004 (IT) RM2004A000075

(51) Int. Cl. C12G 3/07; C12H 1/22

(52) U.S. Cl. 99/277.1

(57) ABSTRACT

A device for aromatising liquids for human consumption, in particular for wine, vinegar and distillates, comprises a main body (2) having at least one wood portion (3). The main body (2) can be associated to a tank for liquids for human consumption and the wooden portion (3) can be immersed at least partially into the liquid for human consumption.

### TECHNICAL FIELD

The present invention relates to a device for aromatising liquids for human consumption, in particular for aromatising wine, vinegar, distillates and the like.

### BACKGROUND ART

To add value to wines, vinegars and distillates, they are allowed to “rest” in particular tanks for a determined period of time. In these tanks, processes take place which in the technical language are called ageing and refinement, during which the tank release aromas to the liquid for human consumption.

Wooden barrels or casks are known for aromatising wines, vinegars and distillates, which release natural aromas contained in the wood, e.g. tannin, for ageing and refining the liquids contained therein.

The Applicant has observed that the prior art devices for aromatising liquids for human consumption, in particular wine, vinegar, distillates can be improved in several respects.

To allow the natural aromas of the wood to be released into the liquid, the wine, vinegar or distillates must be left to “rest” for a long period of time inside the casks. This need leads to the inevitable consequence that it is necessary to wait for a long time before being able to sell the finished product.

Moreover, the pores of the wood whereof the casks are made tend to become obstructed with the accumulated material in suspension in the liquid they contain, leading to a reduced release of aromas and making the casket operational for limited productive cycles. The consequent frequent replacement of the caskets generates high production costs because each individual casket is manufactured by highly specialised craftsmen.

Lastly, if a wine, vinegar or a distillate enriched with a mixture of particular aromas is to be obtained, it is necessary to transfer in sequence the liquid into several casks, each made of a different wood.

### DISCLOSURE OF INVENTION

In this context, the specific technical task of the present invention is to propose a device for aromatising liquids for human consumption, wine, vinegar, distillates, which allows to overcome the aforementioned drawbacks.

In particular, an object of the present invention makes available a device for aromatising wine, vinegar, distillates and the like which allows their aromatisation in shorter times.

An additional object of the present invention is to propose a device for aromatising wine, vinegar and distillates which is more economical than those of the prior art.

Yet a further object of the present invention is to provide a device for aromatising wine, vinegar and distillates and the like which allows to obtain products enriched with a mixture of aromas in shorter, more economical fashion.

The technical task set out above and the specified objects are substantially achieved by a device for aromatising wine, vinegar and distillates and the like comprising the technical characteristics set out in one or more of the appended claims.

Additional characteristics and advantages of the present invention shall become more readily apparent in the indicative, and therefore non limiting, description of a preferred but not exclusive embodiment of a device for aromatising wine, vinegar and distillates and the like, as illustrated in the accompanying drawings in which:

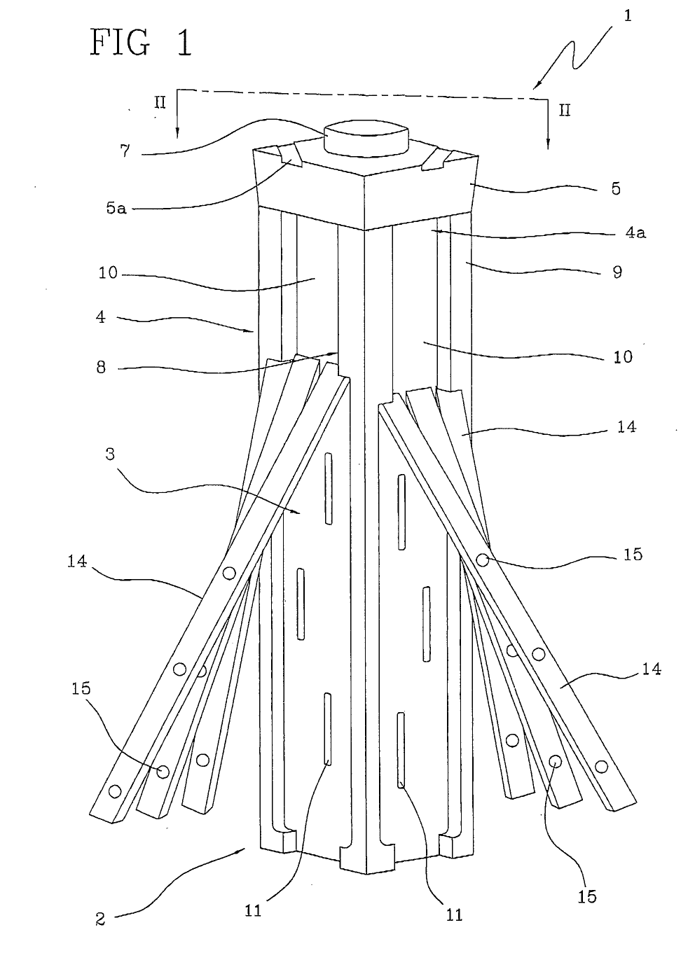

FIG. 1 shows a perspective view of a device for aromatising liquids for human consumption according to the invention,

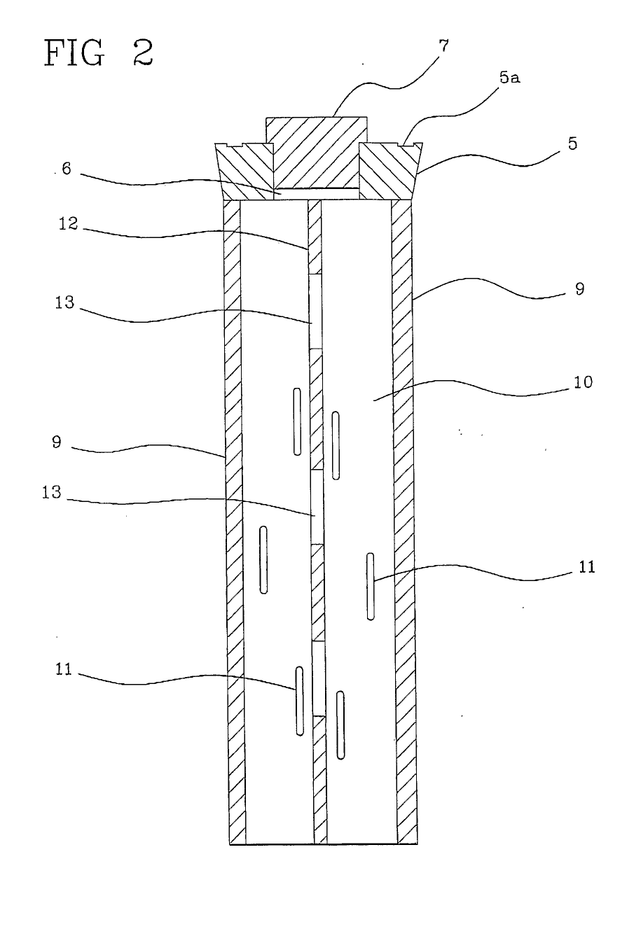

FIG. 2 is a section along the line II-II of the device of FIG. 1.

### DESCRIPTION OF THE ILLUSTRATIVE EMBODIMENTS

With reference to the accompanying figures, the number 1 globally designates a device for aromatising liquids for human consumption according to the present invention.

The device 1 comprises a main body 2, which, advantageously, has at least one portion 3 made of wood, to be partially immersed in a liquid for human consumption obtained by the fermentation of vegetable products. The main body 2 is also able to be associated to a tank (not shown) for liquids of the type specified above.

The main body 2 is substantially constituted by a tubular element 4, which in FIG. 1 has polygonal section but which can also have circular section, and by a head 5 fastened to one end 4a of the tubular element.

Advantageously, the head 5 is able to be engaged in an opening of the tank of liquid for human consumption, thereby serving the function of a spigot, to close the opening of the tank and position the tubular element 4 inside the tank. To restore an access to the inner part of the tank, the head 5 comprises a passage opening 6 and a plug 7 able to be engaged in the passage opening 6 of the head 5. Moreover, the head 5 comprises two recesses 5a able to be engaged by elements (not shown) which bind the tank in order securely to fasten the device 1 to the tank.

The tubular element 4 comprises a frame 8 substantially constituted by at least two uprights 9, in the example of FIG. 1 by four uprights 9. The uprights 9 develop from the head 5, are fastened thereto and serve as supports to at least two panels 10, preferably four, defining the lateral walls of the tubular element 4.

Advantageously, the panels 10 are made of wood to release aromatic substances when they come in contact with a liquid for human consumption.

Just as advantageously, the wood panels 10 comprise at least one hole 11, preferably a plurality of holes 11, both to expand the exchange surface between wood and liquid, and to facilitate the circulation of the liquid inside the tank.

The tubular element 4 further comprises at least one baffle 12, at least partially made of wood, which develops in a plane that is parallel to the axis of development of the tubular element 4 and is contained therein. The baffle 12 also comprises a plurality of holes 12 to expand the exchange surface between wood and liquid and to increase the recirculation of liquid inside the tank which houses the device 1.

Advantageously, at least one wooden strip 14 is externally fastened to the tubular body 4, more in particular to one of the wooden panels 10. Preferably, to each wooden panel 10 is fastened a plurality of wooden strips 14 which comprise a plurality of holes 15.

The wooden strips 14 are advantageously movable between a position of insertion and an operative position.

In the position of insertion the strips 14 are all parallel to the panels 10, more in particular each strip 14 adheres to a panel 10 assuming a lay parallel to the axis of development of the tubular element 4. In this position, the device 1 assumes a configuration of minimum bulk to be inserted inside the tank.

In the operative position, the strips 14 are substantially perpendicular to the panels 10, thereby achieving a configuration which maximises the exchange surface between the wood of the device 1 and the liquid.

The passage between the insertion position and the operative position of the strips 14 occurs during the immersion of the device 1 into the liquid, by the combined effect of the flotation force, whereto are subjected the strips 14, and of a flow of fluid which, entering the tubular element 4, exits through the holes 11 in the panels 10 and acts on the strips 14.

Advantageously, at least one device 1 can be inserted in a cask comprising a plurality of wooden staves. In this case, the wood which constitutes part of the device 1 can be the same as the one that constitutes the staves of the cask or a different one.

Just as advantageously, at least one device 1 can be inserted in a silo for stocking liquids for human consumption such as wine, vinegar and distillates.

The present invention achieves the proposed objects.

Use of the device 1, especially in combination with a wooden casket, allows the aromatisation in rapid times, since to the already known ageing effect of the cask is added the ageing effect of the device 1.

Moreover, the device 1 allows a more economical production of wine, vinegar or distillates than the prior art, because use of the device 1 in combination with a wooden casket increases the productive cycles of the casket by effect of the reduce time of residence of the liquid within the casket itself.

Additionally, use of the device 1 in combination with a silo allows to age the liquid for human consumption contained without using wooden casket, considerably reducing production costs.

Lastly, using a plurality of devices 1, each made of a different wood, in combination with a silo or a casket it is possible to obtain wines, vinegars or distillates enriched with a mixture of aromas in simple and economical fashion, because the need for subsequent transfers into caskets of different wood is eliminated.

1. A device for aromatising liquids for human consumption such as wine, vinegar and distillates, characterised in that it comprises:
a main body (2) having at least one wooden portion (3), said main body (2) being able to be associated to a tank for liquids for human consumption and said at least one wooden portion (3) being able to be at least partially immersed into the liquid for human consumption.

2. Device as claimed in claim 1 wherein said element comprises a tubular element (4).

3. Device as claimed in claim 2 wherein said tubular element (4) comprises a plurality of holes (11).

4. Device as claimed in claim 2 wherein said main body (2) comprises a head (5), fastened to said tubular element (4), to be engaged in removable fashion in an opening of the tank.

5. Device as claimed in claim 4 wherein said tubular element (4) comprises a frame (8) fastened to the head (5); said frame (8) supporting at least two wooden panels (10) which define lateral walls of the tubular element (4).

6. Device as claimed in claim 2 comprising at least one baffle (1) at least partially made of wood, included in a plane that is parallel to the axis of development of the tubular element (4) and contained inside the tubular element (4).

7. Device as claimed in claim 2 comprising at least one wooden strip (14) hinged externally to the tubular element (4).

8. Device as claimed in claim 7 wherein said at least one strip (14) is movable between a position of insertion, wherein the strip (14) lies in a plane that is parallel to the axis of development of the tubular element (4), and an operative position, wherein the strip (14) lies in a plane that is perpendicular to the axis of development of the tubular element (4).

9. Device as claimed in claim 4 wherein said head (5) comprises a passage opening (6) and a plug (7) to close said passage opening (6).

10. Device as claimed in claim 7 wherein said strip (14) comprises a plurality of holes (15).

11. Device as claimed in claim 6 wherein said baffle (12) comprises a plurality of holes (13).

12. Device as claimed in claim 2 comprising a plurality of strips (14) hinged to the tubular element (4).

13. Device as claimed in claim 12 wherein said plurality of strips (14) comprises a plurality of holes (15).

14. A casket, characterised in that it comprises at least one device (1) as claimed in claim 1.

15. Casket as claimed in claim 14 comprising a plurality of wooden staves, the wood of said plurality of staves being different from the wood of the device (1).

16. Casket as claimed in claim 14 comprising a plurality of wooden staves, the wood of said plurality of staves being the same as the wood of the device (1).

17. A silo, characterised in that it comprises at least one device (1) as claimed in claim 1.

18. Device as claimed in claim 3 wherein said main body (2) comprises a head (5), fastened to said tubular element (4), to be engaged in removable fashion in an opening of the tank.

19. Device as claimed in claim 3 comprising at least one baffle (1) at least partially made of wood, included in a plane that is parallel to the axis of development of the tubular element (4) and contained inside the tubular element (4).

20. Device as claimed in claim 3 comprising at least one wooden strip (14) hinged externally to the tubular element (4).
